(19) United States
(12) Patent Application Publication
(10) Pub. No.: US 2003/0043369 A1
(43) Pub. Date: Mar. 6, 2003

(54) Automated optical inspection and marking systems and methods

(75) Inventor: Ann M. Smith, Delano, MN (US)

Correspondence Address: Curtis Brueske, Honeywell International, P. O. Box 2245, 101 Columbia Road, Morristown, NJ, 07962, US

(73) Assignee: Honeywell Advanced Circuits, Inc.

(21) Appl. No.: 09/941,416

(22) Filed: Aug. 28, 2001

(51) Int. Cl. G01N 21/00

(52) U.S. Cl. 356/237.4

(57) ABSTRACT

An automated optical inspection system having a marking system for marking areas of a board containing one or more defects with a mark or marks which are readily visible to the naked eye and which indicated the type of defect in the area being marked. Such systems may be formed from existing systems by attaching a light source to the system camera and using the light source to identify the portion of a board being inspected so that an operator can manually mark the board, or may be systems that include automated or semi-automated marking systems for marking the board.

### FIELD OF THE INVENTION

The field of the invention is automated optical inspection systems.

Background of the Invention

Currently known automated optical inspection (“AOI”) systems often include a scanning mechanism for automatically identifying potential defects in an item being inspected, and a camera as part of an imaging mechanism for visually inspecting the potential defects to determine if they are actual defects. Such systems sometimes also include a marking mechanism capable of placing a dot on the item being inspected at a location on or near any actual defects.

Such systems often store one or more programs that correspond to the item being scanned. Such programs provide the system with knowledge of the item being scanned and the methods to be used to complete the scan. Operation of the system will often start with utilizing a system interface to select the program that corresponds to the board.

After selecting the appropriate program, an item to be inspected may be placed in or on a portion of the system designed to receive the item. The receiving portion of the system may comprise a table, and placing the item to be inspected may involve fastening the item to the table using tooling pins after properly positioning the item on the table.

After positioning the item, a system interface is used to cause automated scanning of the item to take place. When the scanning is complete, the system will have a set of locations corresponding to points where any potential defects are located.

At this point an operator will typically use the imaging portion of the system to visually inspect the areas/points previously identified by the system as containing a potential defect. The imaging portion of the system may include both a camera adapted to provide an operator with an image of a damaged portion of an item being inspected, and a video monitor for displaying the image. The camera will typically have a field of view that covers only a small portion of a surface of the item being inspected, and an enlarged image of the portion of the item being inspected will be displayed on the monitor.

If visual inspection of a location/area confirms that an actual defect exists, the operator can, via the system interface, cause the system to place a dot (generally about 15 mils in diameter) on or near the defect so that the location of the defect can subsequently be determined by repair personnel. This process is generally continued until all the potential defects have been examined, and all the actual defects identified by the operator have been marked.

After actual defects have been marked, the item is removed from the system and subsequently repaired to remove any unwanted shorts and/or opens.

Unfortunately, despite the automated detection mechanisms and semi-automated marking mechanisms, inspection and repair takes longer than is desirable. Thus, there is a continuing need for more efficient methods and devices for inspection and repair.

### SUMMARY OF THE INVENTION

The present invention is directed to an automated optical inspection system having a marking system for marking areas of a board containing one or more defects with a mark or marks which are readily visible to the naked eye and which indicated the type of defect in the area being marked. Such systems may be formed from existing systems by attaching a light source to the system camera and using the light source to identify the portion of a board being inspected so that an operator can manually mark the board. Systems that include automated or semi-automated marking systems for properly marking the board are also contemplated.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows a prior art AOI system.

FIG. 2 shows a schematic view of an AOI system in accordance with the invention.

### DETAILED DESCRIPTION

It has been found that using an improved method to mark defects on an item, such as a printed wiring board being inspected, can significantly improve the throughput of an inspection and repair process. Instead of simply marking the location of a defect with a small dot, it is better to mark the location utilizing a larger marking such as a circle or square that encloses the damaged portion. Larger marks tend to be more readily located by repair personnel. It is contemplated that marks which define an area approximately 500 mils (½ inch) across may be advantageously used. However, marks which define smaller areas may also be utilized. It is contemplated that marks defining an area greater than 100 mils across would be acceptable, an area greater than 300 mils desirable, and an area greater than 400 mils even more desirable. A mark may comprise a single closed figure or symbol, or may comprise a plurality of figures, symbols, marks, etc. which enclose or otherwise define an area having the desired size.

In addition to using larger markings, it is desirable to use markings that provide an indication of the type of defect being marked. Thus, if the defect is an open it may be enclosed in a circle. If a short, it may be enclosed in a square. Using marks that indicate the type of defect marked provide information to repair personnel in a quick and direct fashion. Repair personnel need no longer take the time to reexamine each defect to determine the action required to repair it. Moreover, repairs of defects can be done in a batch fashion based on type as all defects of a similar type are readily identified by repair personnel. As an example, one may first fix all the shorts by repairing all the defects enclosed in circles, and subsequently fix all opens by repairing all the defects enclosed in squares.

Although preferred markings will enclose an area containing a defect, alternative markings may simply provide a sufficiently large visual indicator of the location and type of a defect without actually enclosing an area containing the defect.

For a given embodiment the marking mechanism used may be an automated one, or many be a manual one which requires an operator to write/place marks directly on the item being inspected. Although the automated mechanism may be more desirable in many instances, the manual mechanism may be readily adapted into existing AOI systems.

Although the AOI systems described have applicability to many different types of items, they are particularly useful in inspecting printed wiring boards, interconnects, and metalized layers. For the sake of readability, the term “board” will be utilized in place of the phrase “item to be inspected” in the remainder of this disclosure. However, it should be kept in mind when reading the rest of this disclosure and the claims that the term board is intended to mean “item to be inspected”.

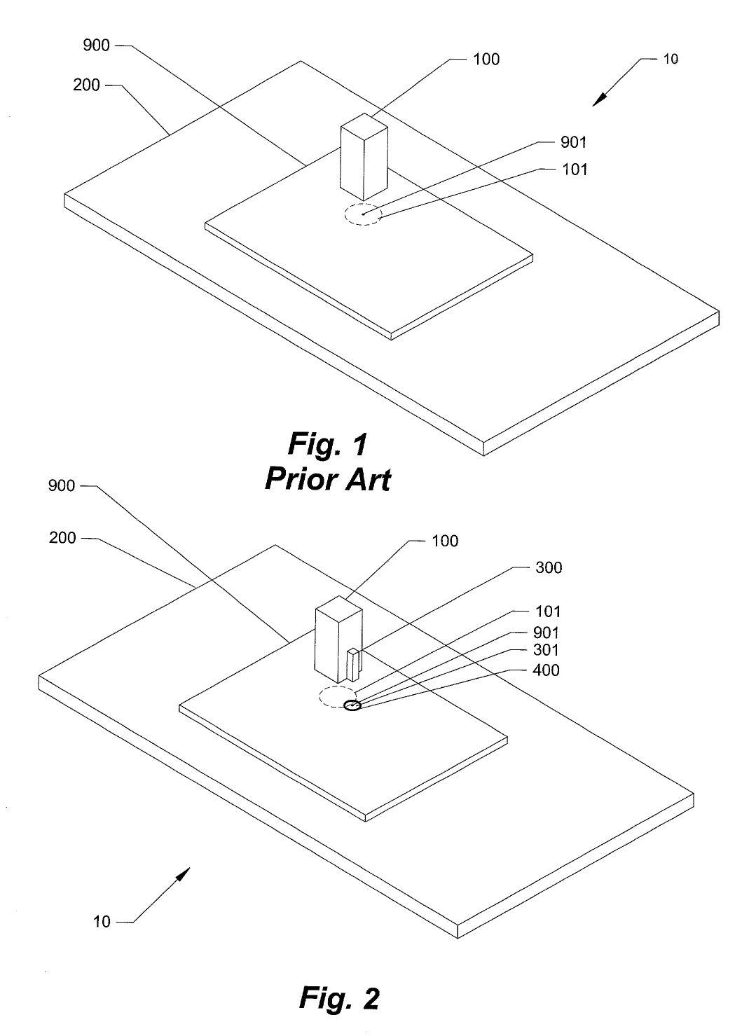

Referring to FIG. 1, a prior art AOI system 10 comprises a camera/imaging mechanism 100, and an item receiving portion/table 200. Camera 100 and camera 200 are generally moveably coupled to each other via various mechanisms and structural members of system 10. Board 900 is an item to be inspected and marked which is currently positioned within the receiving portion/table 200 of AOI system 10. Camera 100 is adapted to provide an operator with an image of a damaged/defective portion 901 of the board 900, and has a field of view 101 that covers only a small portion of the board 900.

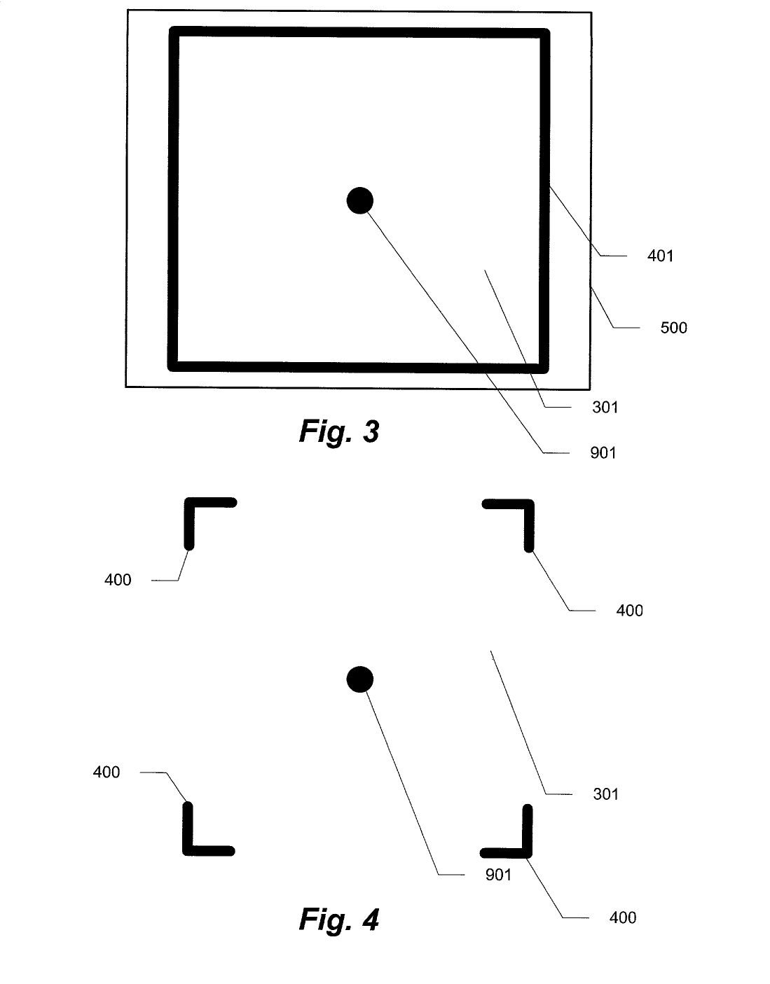

Referring to FIG. 2, such an AOI system may be easily modified to include a light source 300 to facilitate in the marking process, possibly by simply fastening the light source to camera 100.

Light source 300 is adapted to illuminate a portion of the board such that the illuminated portion 301 identifies the location of the damaged portion 901 that is currently, or was most recently, in the field of view 101 of camera 100, and that was identified by an operator as containing an actual defect. It is important that the illuminated portion 101 of the board 301 be visible from outside the AOI system, preferably to the naked eye of an operator so as to allow the operator to locate and mark the damaged portion of the board. Although many different types of light sources would be suitable for use as light source, a low power laser such as a laser pointer is acceptable.

It should be noted that system 10 preferably leaves board 900 sufficiently exposed that an observer/operator has access to board 900 and is able to mark board 900 with one or more marks 400 to identify the location of the damaged portion 901 of the board as well as the type of damage contained in the damaged portion 901 of the board and/or the type of action necessary to repair the damaged portion 901.

Operation of such a modified system will differ from that of prior art systems in a number of ways, one of which is that once an actual defect/damaged portion 901 has been identified, instead of instructing the AOI system to mark the location, light source 300 will be turned on and/or positioned as necessary to identify the location of an area containing the defect, and the operator will then manually write, stamp, or otherwise place the appropriate mark or marks 400 on the board.

It is contemplated that in some embodiments the light source 300 will be incorporated in the AOI system in a manner that does not allow it to identify the location of a portion of the board at the same time that that portion of the board is within the field of view of camera 100. In some instances this will be compensated for by including a step for moving the light source after a defect has been identified. If the light source is attached to the camera, the movement step may simply involve offsetting the position of the camera by a pre-determined amount to move the laser, and the location of the illuminated portion of the board, to an appropriate location. Referring to FIG. 2, it can be seen that light source 300 is attached to the outside of camera 100 and the spot of light/indicator 301 that it produces is located adjacent to rather than within the field of view 101 of camera 100. Thus, to position indicator 301 over defect 901 as shown, the position of camera 100 must be moved to reposition indicator 301 over defect 901.

Alternative systems may include automatic marking methods capable of marking the item in the manner previously described. In such a system, the systems marking mechanism would need to be adapted to mark the board with the appropriate mark or marks 400. The determination of the type of mark to be used may be done automatically by the system and then verified by an operator, or may be manually selected by the operator via a system user interface. Manual selection may involve identifying the type of the defect, or may involve specifying the mark or marks to be used. It is contemplated that it may also be advantageous to provide visual feedback to the operator regarding the orientation and positions of the marks prior to their being placed on the board. Such visual feedback may be accomplished in many different ways such as by displaying an overlay 401 on the monitor 500 (see FIG. 3) being used to visually inspect the board 900 to show where on the board 900 the mark 400 will be placed. The system would preferably display a WSIWYG (what-you-see-is-what-you-get) image 401 that corresponded to the currently selected size, color, shape, and/or orientation of the mark or marks 400 to be placed on the board 900. Such a system may or may not include a light source 300 providing an area of increased brightness 301.

In FIG. 4, marks 400 still identify an area of board 900 containing a defect 901, but marks 400 do not comprise a single symbol or figure, but rather a plurality of symbols.

Thus, specific embodiments and applications of improved optical inspection and marking systems and methods have been disclosed. It should be apparent, however, to those skilled in the art that many more modifications besides those already described are possible without departing from the inventive concepts herein. The inventive subject matter, therefore, is not to be restricted except in the spirit of the appended claims.

What is claimed is:

1. An automated optical system comprising a camera adapted to provide an operator with an image of a damaged portion of an item being inspected, and a light source adapted to illuminate a portion of the item being inspected such that the illuminated portion identifies the location of the damaged portion, and is visible from outside the automated optical system to the naked eye of an observer looking at the item being inspected.

2. The automated optical system of claim 1 wherein the system comprises a marking mechanism adapted to mark the item being inspected in a manner which identifies the location of the damaged portion of the item as well as the type of damage contained in the damaged portion of the item.

3. The automated optical system of claim 2 wherein the item being inspected is sufficiently exposed to allow an observer to manually mark the item being inspected.

4. The automated optical system of claim 3 wherein the light source is a low power laser.

5. A method for identifying a defect in an item comprising:
providing an item to be examined;
utilizing an automated detection method to identify a potential defect in the item;
marking the item in a manner which identifies the area of the item containing the defect, and in a manner which indicates the type of action required to correct the defect.

6. The method of claim 5 wherein, prior to marking the item, the item is visually inspected to verify that the potential defect is an actual defect.

7. The method of claim 6 wherein marking the item is done manually.

8. The method of claim 7 wherein a light source is used to identify the area to be marked.

9. The method of claim 8 wherein the light source comprises a low power laser.

11. A method for identifying a defect in an item comprising:
providing an automated optical system having a camera adapted to provide an operator with an image of a damaged portion of an item being inspected, and a laser light source adapted to illuminate a portion of the item being inspected such that the illuminated portion identifies the location of the damaged portion, and is visible from outside the automated optical system to the naked eye of an observer looking at the item being inspected;
providing an item to be examined an placing it in the provided automated optical system; utilizing the provided automated optical system to identify a potential defect in the item; visually inspecting the item to verify that the potential defect is an actual defect; manually marking the item in a manner which identifies the area of the item containing the defect, and in a manner which indicates the type of action required to correct the defect.

12. The method of claim 11 wherein providing an automated optical system comprises taking an existing automated optical system and coupling a low power laser to a camera of the automated optical system as the laser light source adapted to illuminate a portion of the item being inspected.

13. A method of modifying an automated optical system which includes a camera portion, the method comprising fastening a low power laser to the camera such that the laser, when turned on, provides a visual indication of the location of an area which is currently within the field of view of the camera.
